(19) United States
(12) Patent Application Publication
(10) Pub. No.: US 2020/0270879 A1
(43) Pub. Date: Aug. 27, 2020

(54) CONSTRUCTIVE PROCESS BY DIRECT APPLICATION OF EPOXY GROUT IN THE GAPS BETWEEN CERAMIC COATINGS OR OTHER MATERIALS

(71) Applicant: HARD COMÉRCIO DE FIXADORES E RESINAS LTDA, Joinville SC (BR)

(72) Inventor: LARRI HENRIQUE HARTMANN, Joinville (BR)

(73) Assignee: HARD COMÉRCIO DE FIXADORES E RESINAS LTDA, Joinville SC (BR)

(21) Appl. No.: 16/574,568

(22) Filed: Sep. 18, 2019

(30) Foreign Application Priority Data
Feb. 25, 2019 (BR) BR1020190037849

(51) Int. Cl. E04F 21/165

(52) U.S. Cl. CPC E04F 21/165; C04B 2111/70

(57) ABSTRACT

Referred innovation is a constructive process by direct application of epoxy grout in the gaps between ceramic coatings or other materials, which provides uniformity and homogeneity in the application of the grout, through the use of an epoxy grout compound, mixed in the homogenizing nozzle of a tubular double pipe, where the reagents acquire the desired physical-chemical characteristics, transforming into the epoxy grout mass to be applied, furnishing the controlled distribution of the epoxy grout by the nozzle of the pistol directly in the trail of the gaps, in a continuous and uniform manner, without pouring any excess to the sides.

### FIELD OF THE INVENTION

The present innovation refers to a constructive process by direct application of epoxy grout in the gaps between ceramic coatings or other materials, where there is a double applicator which at one of its extremities has a trigger that, pushed, directs the liquid contents existing in the parallel and individual reservoirs of the applicator for a homogenizing nozzle, which uniformly mixes said contents from the applicator reservoirs, forming an epoxy compound apt to be applied in the gaps or spaces between the ceramic coatings or other materials used in civil construction, so as to result in the grouting of the floor or walls tiles of a preferred environment.

### BACKGROUND OF THE INVENTION

As is well known to those skilled in the art, grouting is the constructive procedure responsible for filling gaps between the tile coatings and for offsetting the variation of the measurements or its framing, helping to ensure the effectiveness and giving excellent esthetics appeals to the coatings.

Also, the final esthetics of said grouted tiles has become a prime factor when selecting the product and application process by the consumer, due to the fact that the joints must have the most imperceptible arrangement as possible, so as not to interfere with the appearance of the floor or wall coatings, which are becoming more sophisticated every day.

Currently the types of grout on the marketplace are of the cement-based powder type, that when mixed together with water transforms themselves into a mass, which is then applied in the gaps between tiles by pouring and spreading said mass using a grout floating tool or a trowel, however, this process many times results in the mass not penetrating nor completely filling all the areas of this gaps due to the bad distribution of the material, leaving behind empty spaces inside the grouted structure, consequently, this regions would become fragile, brittle and esthetically imperfect, besides, this application process produces a huge mess, requiring more time for cleaning all its residuals and, naturally, elevating the labor costs e manpower needed.

Another existing problem in the known application processes, particularly the cement type, is that said bad distribution of the grout generates a lot of mass excess along the sides of the gaps, which needs to be removed and disposed of, again elevating costs.

Another disadvantage of the powder grout is that it does not possess physical characteristics such as expansion/contraction coefficients, in other words, doesn't possess characteristics to absorb the “involuntary work” by the dilation of the floor tiles, consequently, the chance of these tiles broke or suffer damages would be very high.

Another disadvantage of the powder grout, is that residual materials and dirties easily become encrusted in its structure, detonating over time the color of the grouted mass.

### SUMMARY OF THE INVENTION

In order to avoid these inconvenient situations and to surpass all the said disadvantages involved, it were developed a constructive process by direct application of epoxy grout in the gaps between ceramic coatings or other materials, which provides uniformity and homogeneity in the application of the grout, through the use of an epoxy grout compound, mixed in the homogenizing nozzle of a tubular double vessel, where the reagents acquire the desired physical-chemical characteristics, transforming into the epoxy grout mass ready to be applied.

### BRIEF DESCRIPTION OF THE DRAWINGS

For further definition and understanding of the invention the following attached figures will be shown, namely:

FIG. 1—Schematic view exemplifying the use of the constructive process by direct application of epoxy grout in the gaps between ceramic coatings or other materials;

FIG. 2—Detail exemplifying the use of the constructive process by direct application of epoxy grout in the gaps between ceramic coatings or other materials.

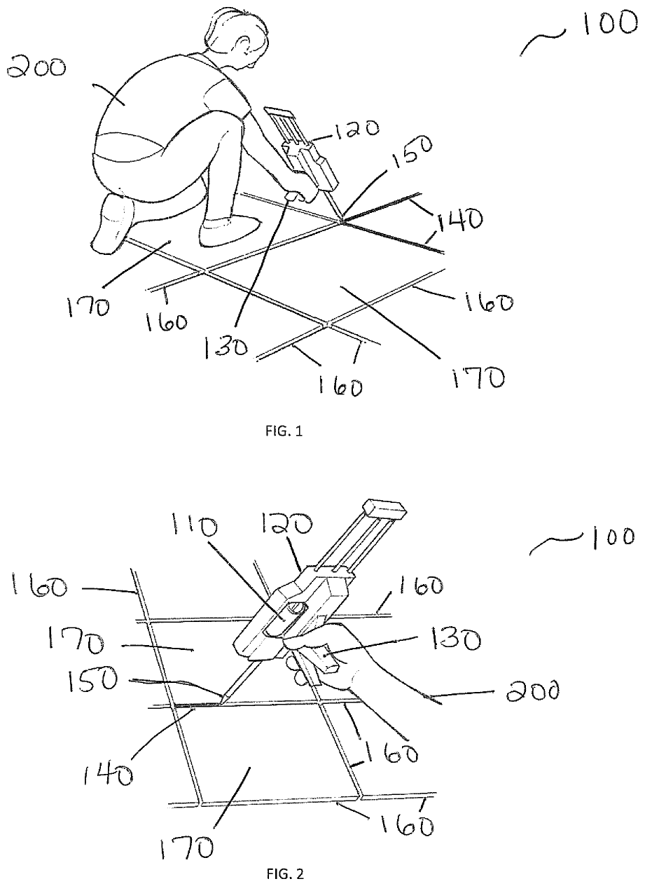

### DETAILED DESCRIPTION OF THE PREFERRED EMBODIMENT

Said application process 100 occurs when the professional of the area 200 insert a epoxy grout tube 110 in a mechanic pistol body of axial movement 120, then pull its trigger 130, causing linear mechanic pressure in the content of the tube 110, providing the controlled distribution of the epoxy grout 140 by the nozzle 150 of the pistol 120 directly in the trail of the gaps 160, in a continuous and uniform manner, without pouring any excess to the sides, resulting in a clean process, avoiding any material waste and granting a perfect esthetic appearance due to the epoxy being a grout that do not absorb incrustations, also, possessing substantial elastic coefficient to adapt itself to the variations on the roof tiles 170 concerning the differences in ambient temperature, implementing a perfectly impenetrable grout 140 in said gaps 160, preventing the humidity or any other liquid residues to pass through the tile coating to the walls or masonry floors.

With the described application process and appropriate grouting material for said procedure, it is possible to increase the productivity and eliminate the tiles 170 cleaning necessity after the application of the grout 140, consequently, reducing substantially the costs of the construction process.

What is claimed is:

1. Constructive process by direct application of epoxy grout in gaps between ceramic coatings or other materials, comprising:
An application process that occurs when (a) a professional of the area inserts an epoxy grout tube in a mechanic pistol body of axial movement said pistol body having a trigger and a nozzle, then (b) pulls said trigger, causing linear mechanic pressure in a content of the tube, providing the controlled distribution of the epoxy grout by the nozzle of the pistol directly in the trail of the gaps, in a continuous and uniform manner, without pouring any excess to a side of the gaps.
